(19) United States
(12) Patent Application Publication
(10) Pub. No.: US 2025/0016736 A1
(43) Pub. Date: Jan. 9, 2025

(54) WIRELESS COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 18/891,851

(22) Filed: Sep. 20, 2024

Related U.S. Application Data
(63) Continuation of application No. PCT/CN2022/088514, filed on Apr. 22, 2022.

(51) Int. Cl. H04W 68/00; H04W 8/24

(52) U.S. Cl. CPC H04W 68/005; H04W 8/24

(57) ABSTRACT

A wireless communication method and an apparatus are provided. The method includes: receiving, by a first access network device, first information, where the first information is used to indicate a terminal device capability of a first terminal device. In embodiments of this application, first information is sent to a first access network device, where the first information may be used to indicate a terminal device capability of a first terminal device. Introduction of the first information helps the access network device determine whether there is a need to send a paging message for the first terminal device, so that a paging resource may be saved.

### CROSS-REFERENCE TO RELATED APPLICATIONS

This application is a continuation of International Application No. PCT/CN2022/088514, filed on Apr. 22, 2022, the disclosure of which is hereby incorporated by reference in its entirety.

### TECHNICAL FIELD

This application relates to the technical field of communications, and more specifically, to a wireless communication method and a communications apparatus.

### BACKGROUND

In a communication process, an access network device receives a paging message for a terminal device from a core network device or another access network device. After receiving the paging message, the access network device directly sends the paging message for the terminal device. However, sending of some paging messages may be unnecessary (or useless). Directly sending such paging messages wastes paging resources.

### SUMMARY

Embodiments of this application provide a wireless communication method and a communications apparatus. Various aspects involved in embodiments of this application are described below.

According to a first aspect, a wireless communication method is provided. The method includes: receiving, by a first access network device, first information, where the first information is used to indicate a terminal device capability of a first terminal device.

According to a second aspect, a wireless communication method is provided. The method includes: sending first information to a first access network device, where the first information is used to indicate a terminal device capability of a first terminal device.

According to a third aspect, a communications apparatus is provided. The communications apparatus is located in a first access network device. The communications apparatus includes: a communications module, configured to receive first information, where the first information is used to indicate a terminal device capability of a first terminal device.

According to a fourth aspect, a communications apparatus is provided. The apparatus includes: a communications module, configured to send first information to a first access network device, where the first information is used to indicate a terminal device capability of a first terminal device.

According to a fifth aspect, a communications apparatus is provided. The apparatus includes a memory and a processor, where the memory is configured to store a program, and the processor is configured to invoke the program in the memory to execute the method according to either of the first aspect or the second aspect.

According to a sixth aspect, an apparatus is provided. The apparatus includes a processor, configured to invoke a program from a memory to execute the method according to either of the first aspect or the second aspect.

According to a seventh aspect, a chip is provided. The chip includes a processor, configured to invoke a program from a memory to cause a device installed with the chip to execute the method according to either of the first aspect or the second aspect.

According to an eighth aspect, a computer-readable storage medium is provided, where a program is stored on the computer-readable storage medium, and the program causes a computer to execute the method according to either of the first aspect or the second aspect.

According to a ninth aspect, a computer program product is provided. The computer program product includes a program, where the program causes a computer to execute the method according to either of the first aspect or the second aspect.

According to a tenth aspect, a computer program is provided, where the computer program causes a computer to execute the method according to either of the first aspect or the second aspect.

In embodiments of this application, first information is sent to a first access network device, where the first information may be used to indicate a terminal device capability of a first terminal device. Introduction of the first information helps the access network device determine whether there is a need to send a paging message for the first terminal device. For example, the access network device may determine, based on the terminal device capability indicated by the first information and a device capability of the access network device, whether it is necessary to send a paging message for the first terminal device.

### BRIEF DESCRIPTION OF DRAWINGS

FIG. 1A to FIG. 1C each are a system architectural diagram of a communications system to which an embodiment of this application is applicable.

FIG. 2 is a schematic flowchart of a wireless communication method according to an embodiment of this application.

FIG. 3 is an example diagram of a possible implementation of the method shown in FIG. 2.

FIG. 4 is an example diagram of another possible implementation of the method shown in FIG. 2.

FIG. 5 is a schematic structural diagram of a communications apparatus according to an embodiment of this application.

FIG. 6 is a schematic structural diagram of a communications apparatus according to another embodiment of this application.

FIG. 7 is a schematic structural diagram of an apparatus according to an embodiment of this application.

### DESCRIPTION OF EMBODIMENTS

### Communications System Architecture

The technical solutions in embodiments of this application may be applied to various communications systems, for example, a global system for mobile communications (GSM), a code-division multiple access (CDMA) system, a wideband code-division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, an NTN system, a universal mobile telecommunications system (UMTS), a wireless local area network (WLAN), wireless fidelity (WiFi), a fifth-generation (5G) system, or another communications system, for example, a future communications system such as a sixth-generation mobile communications system or a satellite communications system.

Generally, a quantity of connections supported by a conventional communications system is limited, and is also easy to implement. However, with development of communication technologies, a mobile communications system not only supports conventional communication, but also supports, for example, device-to-device (D2D) communication, machine-to-machine (M2M) communication, machine type communication (MTC), vehicle-to-vehicle (V2V) communication, or Internet of vehicles (V2X) communication. Embodiments of this application may also be applied to these communications systems.

The communications system in embodiments of this application may be applied to a carrier aggregation (CA) scenario, may be applied to a dual connectivity (DC) scenario, or may be applied to a standalone (SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial communication network (TN) system. By way of example rather than limitation, the NTN system includes an NR-based NTN system and an IoT-based NTN system.

Embodiments of this application are described with reference to an access network device and a terminal device. The terminal device may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus.

In embodiments of this application, the terminal device may be a station (ST) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system, for example, an NR network, a terminal device in a future evolved public land mobile network (PLMN), or the like.

The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) vehicle, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. Optionally, the terminal device may be configured to serve as a base station. For example, the terminal device may function as a scheduling entity, which provides a sidelink signal between terminal devices in V2X, D2D, or the like. For example, a cellular phone and a vehicle communicate with each other by using a sidelink signal. A cellular phone and a smart home device communicate with each other, without relaying a communication signal by using a base station.

In embodiments of this application, the terminal device may be deployed on land indoors or outdoors, may be handheld, wearable, or vehicle-mounted, may be deployed on water (for example, on a ship), or may be deployed in the air (for example, on an airplane, a balloon, or a satellite).

In embodiments of this application, the terminal device may be a mobile phone, a pad, a computer with a wireless transceiver function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, or the like. The terminal device involved in embodiments of this application may also be referred to as a terminal, user equipment (UE), an access terminal device, a vehicle-mounted terminal, an industrial control terminal, a UE unit, a UE station, a mobile site, a mobile station, a remote station, a remote terminal device, a mobile device, a UE terminal device, a wireless communications device, a UE agent, a UE apparatus, or the like. The terminal device may also be fixed or mobile.

By way of example rather than limitation, in embodiments of this application, the terminal device may alternatively be a wearable device. The wearable device may also be referred to as a smart wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, smart wearable devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelry for physical sign monitoring.

The access network device in embodiments of this application may be a device configured to communicate with a terminal device. The access network device may be, for example, a base station. The access network device in embodiments of this application may be a radio access network (RAN) node (or device) that connects the terminal device to a wireless network. The base station may broadly cover the following various names, or may be replaced with the following names, such as a Node B, an evolved NodeB (eNB), a next-generation NodeB (gNB), a relay station, an access point, a transmitting and receiving point (TRP), a transmitting point (TP), a master MeNB, a secondary SeNB, a multi-standard radio (MSR) node, a home eNodeB, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in a future communications system, or the like. The base station may support networks with a same access technology or different access technologies. A specific technology and a specific device form used by the access network device are not limited in embodiments of this application.

The base station may be stationary or mobile. For example, a helicopter or an unmanned aerial vehicle may be configured to serve as a mobile base station, and one or more cells may move according to a location of the mobile base station. In other examples, a helicopter or an unmanned aerial vehicle may be configured to serve as a device in communication with another base station.

In some deployments, the access network device in embodiments of this application may be a CU or a DU, or the access network device includes a CU and a DU. A gNB may further include an AAU.

The access network device and the terminal device may be deployed on land indoors or outdoors, handheld, or vehicle-mounted, may be deployed on water, or may be deployed on an airplane, a balloon, or a satellite in the air. In embodiments of this application, a scenario in which the access network device and the terminal device are located is not limited.

By way of example rather than limitation, in embodiments of this application, the access network device may have a mobility feature. For example, the access network device may be a mobile device. In some embodiments of this application, the access network device may be a satellite or a balloon station. For example, the satellite may be a low-earth orbit (LEO) satellite, a medium-earth orbit (MEO) satellite, a geostationary earth orbit (GEO) satellite, a high elliptical orbit (HEO) satellite, or the like. In some embodiments of this application, the access network device may alternatively be a base station disposed on land, in water, or in other locations.

In embodiments of this application, the access network device may provide a service for a cell. The terminal device communicates with the access network device by using a transmission resource (for example, a frequency domain resource or a spectrum resource) used by the cell. The cell may be a cell corresponding to the access network device (for example, a base station). The cell may belong to a macro base station or may belong to a base station corresponding to a small cell. The small cell herein may include a metro cell, a micro cell, a pico cell, a femto cell, or the like. These small cells have characteristics of a small coverage range and low transmit power, and are applicable to providing a high-rate data transmission service.

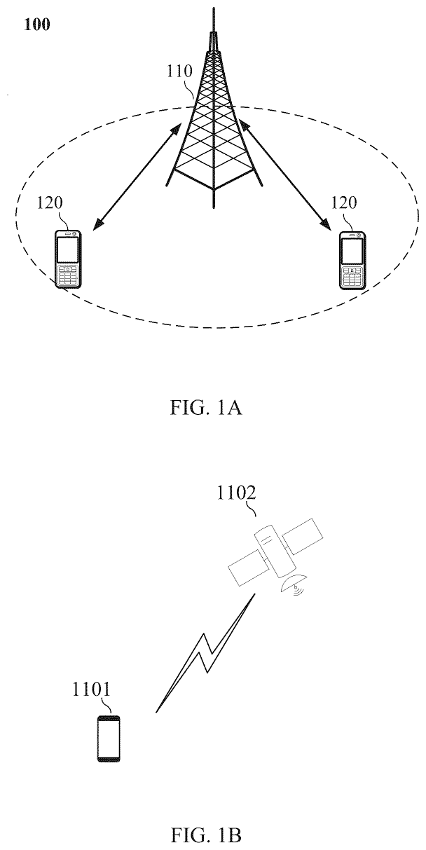

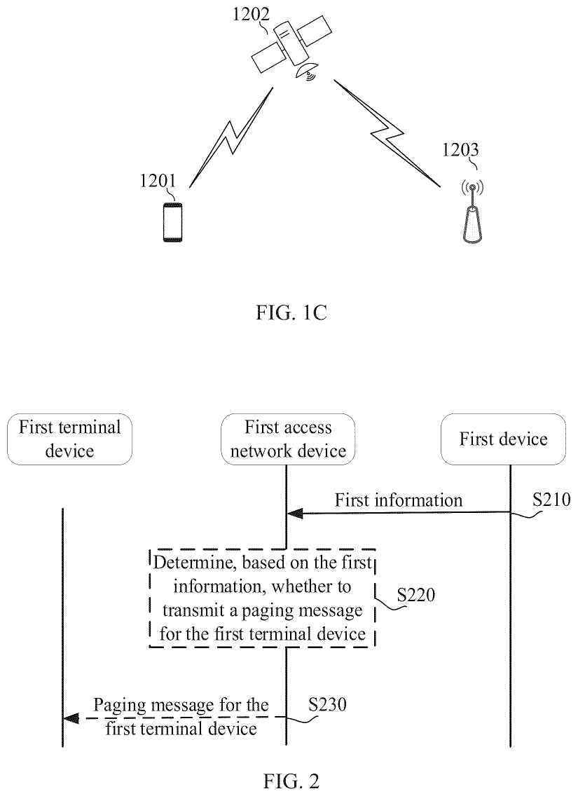

Exemplarily, FIG. 1A is a schematic diagram of an architecture of a communications system according to an embodiment of this application. As shown in FIG. 1A, the communications system 100 may include an access network device 110, and the access network device 110 may be a device that communicates with a terminal device 120 (or referred to as a communications terminal or a terminal). The access network device 110 may provide communication coverage for a specific geographic area, and may communicate with a terminal device located in the coverage area.

FIG. 1A exemplarily shows one access network device and two terminal devices. In some embodiments of this application, the communications system 100 may include a plurality of access network devices, and another quantity of terminal devices may be included within a coverage range of each access network device, which is not limited in embodiments of this application.

Exemplarily, FIG. 1B is a schematic diagram of an architecture of another communications system according to an embodiment of this application. Referring to FIG. 1B, a terminal device 1101 and a satellite 1102 are included, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may function as a base station, and direct communication may be performed between the terminal device 1101 and the satellite 1102. Under this system architecture, the satellite 1102 may be referred to as an access network device. In some embodiments of this application, the communications system may include a plurality of access network devices 1102, and another quantity of terminal devices may be included within a coverage range of each access network device 1102, which is not limited in embodiments of this application.

Exemplarily, FIG. 1C is a schematic diagram of an architecture of another communications system according to an embodiment of this application. Referring to FIG. 1C, a terminal device 1201, a satellite 1202, and a base station 1203 are included, wireless communication may be performed between the terminal device 1201 and the satellite 1202, and communication may be performed between the satellite 1202 and the base station 1203. A network formed between the terminal device 1201, the satellite 1202, and the base station 1203 may also be referred to as an NTN. In the architecture of the communications system shown in FIG. 1C, the satellite 1202 may not function as a base station, and communication between the terminal device 1201 and the base station 1203 needs to be relayed by using the satellite 1202. Under such a system architecture, the base station 1203 may be referred to as an access network device. In some embodiments of this application, the communications system may include a plurality of access network devices 1203, and another quantity of terminal devices may be included within a coverage range of each access network device 1203, which is not limited in embodiments of this application.

It should be noted that FIG. 1A to FIG. 1C are merely examples of a system to which this application applies. Certainly, the methods shown in embodiments of this application may also be applied to another system, such as a 5G communications system or an LTE communications system. This is not specifically limited in embodiments of this application.

In some embodiments of this application, the wireless communications systems shown in FIG. 1A to FIG. 1C may further include another network entity such as a mobility management entity (MME) or an access and mobility management function (AMF), which is not limited in embodiments of this application.

It should be understood that a device having a communication function in a network or a system in embodiments of this application may be referred to as a communications device. The communications system 100 shown in FIG. 1A is used as an example. The communications device may include an access network device 110 and a terminal device 120 that have a communication function. The access network device 110 and the terminal device 120 may be the foregoing specific devices, and details are not described herein again. The communications device may further include another device in the communications system 100, such as a network controller or a mobility management entity. This is not limited in embodiments of this application.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

“Configured” in embodiments of this application may include being configured by using at least one of a system message, radio resource control (RRC) signalling, or a medium access control control element (MAC CE).

In some embodiments of this application, the “predefined” or “preset” may be implemented in a manner in which corresponding code, a table, or other related information that may be used for indication is pre-stored in a device (for example, including a terminal device and an access network device). A specific implementation thereof is not limited in this application. For example, predefinition may refer to being defined in a protocol.

In some embodiments of this application, the “protocol” may refer to a standard protocol in the communication field, which may include, for example, an LTE protocol, an NR protocol, and a related protocol applied to a future communications system. This is not limited in this application.

At present, in pursuit of rate, delay, high-speed mobility, energy efficiency, and the diversity and complexity of services in future life, the 3rd Generation Partnership Project (3GPP), an international organization for standardization, has started developing 5G. Main application scenarios of 5G are: enhanced mobile broadband (eMBB), ultra-reliable low latency communications (URLLC), and massive machine type communication (mMTC). eMBB aims to provide a user with access to multimedia content, services, and data. The demand for eMBB is growing rapidly. In addition, since eMBB may be deployed in different scenarios, such as indoor, urban, or rural areas, its capabilities and requirements vary greatly. Therefore, applying a same standard to all is impractical, and a detailed analysis must be conducted in conjunction with a specific deployment scenario. Typical applications of URLLC include industrial automation, electric power automation, remote medical operations (surgery), traffic safety guarantee, and the like. Typical features of mMTC include high connection density, small data volume, delay-insensitive services, low cost and long service life of modules.

In addition, 3GPP is currently studying the NTN technology. NTN generally provides a terrestrial user with communication services through satellite communication. Satellite communication has many unique advantages over terrestrial cellular network communication.

First, satellite communication is not limited by a geographic location of a user. For example, a general terrestrial communication network cannot cover an area such as an ocean, a mountain, or a desert in which an access network device cannot be set up. Alternatively, the terrestrial communication network does not cover some sparsely-populated areas. However, for satellite communication, since a satellite may cover a relatively large terrestrial area, and the satellite may orbit the earth, theoretically, every corner of the earth may be covered by a satellite communication network.

Second, satellite communication has great social value. Satellite communication may cover remote mountainous areas, impoverished countries or regions at relatively low costs, thereby enabling people in these regions to enjoy advanced voice communication and mobile internet technologies. From this point of view, satellite communication is conducive to narrowing a digital divide with developed regions and promoting development of these regions.

Third, satellite communication has an advantage of long distance, and an increase in a communication distance does not significantly increase communication costs.

Finally, satellite communication has high stability, and is not susceptible to the impact of natural disasters.

According to different orbital altitudes, communications satellites may be classified into a low-earth orbit (LEO) satellite, a medium-earth orbit (MEO) satellite, a geostationary earth orbit (GEO) satellite, a high elliptical orbit (HEO) satellite, and the like. At this stage, the main study is on the LEO satellite and the GEO satellite.

An altitude of the LEO satellite generally ranges from 500 km to 1500 km. Correspondingly, an orbital period of the LEO satellite is about 1.5 hours to 2 hours. For the LEO satellite, a signal propagation delay of single-hop communication between users is generally less than 20 ms. A maximum satellite visible time of the LEO satellite is about 20 minutes. The LEO satellite has advantages of short signal propagation distance, small link loss, and low transmit power requirement for a terminal device of a user.

An orbital altitude of the GEO satellite is 35786 km. A period for the GEO satellite to rotate around the earth is 24 hours. For the GEO satellite, a signal propagation delay of single-hop communication between users is generally about 250 ms.

To ensure satellite coverage and improve system capacity of an entire satellite communications system, the satellite generally uses a plurality of beams to cover a terrestrial area. Therefore, one satellite may form dozens or even hundreds of beams to cover the terrestrial area. One beam of a satellite may cover a terrestrial area with a diameter of approximately tens to hundreds of kilometers. Currently, an NTN system includes an NR-NTN system and an internet of things (IoT)-NTN system.

In the main application scenario of 5G mentioned above (such as eMBB) or in the NTN scenario, the access network device receives a paging message for the terminal device. In a related technology, after receiving the paging message for the terminal device, the access network device directly sends the paging message, so as to implement paging of the terminal device in a cell corresponding to the access network device. However, one or some paging messages sent by the access network device may be useless or unnecessary.

For example, some terminal devices may support only a half-duplex mode. A terminal device that supports only the half-duplex mode cannot simultaneously perform sending and receiving operations. However, the access network device may not implement the half-duplex mode. Therefore, the access network device does not allow or does not support access of the terminal device in the half-duplex mode. In this case, for a terminal device that supports only the half-duplex mode, it is unnecessary for the access network device to send a paging message for such a terminal device, because the terminal device that supports only the half-duplex mode is unlikely to reside in a cell of the access network device.

For another example, in a case that the terminal device expects to access the NTN, the terminal device may need to have one or some essential capabilities (referred to as NTN essential capabilities), such as a satellite positioning capability. In a case that a terminal device does not have an NTN access capability, and a cell corresponding to the access network device is an NTN cell, it is unnecessary for the access network device to directly send, in the NTN cell, a paging message for the terminal device, because the terminal device cannot access the NTN cell.

In conclusion, in some cases, sending of one or some paging messages is unnecessary or useless. In a case that the access network device directly sends the paging message, a paging resource may be wasted. In addition, sending of such a paging message may also increase a paging false alarm of another terminal device, consequently increasing power consumption of the another terminal device. For example, the another terminal device may share a paging occasion (PO) with the terminal device. The another terminal device needs to decode a physical downlink shared channel (PDSCH) before it can be determined whether the paging message is a paging message sent to the another terminal device itself. This decoding process is actually unnecessary, and is simply power waste of the another terminal device.

In view of the foregoing problem, in embodiments of this application, first information is sent to the access network device. The first information may be used to indicate a terminal device capability of the terminal device. Introduction of the first information helps the access network device control sending of a paging message, avoiding transmission of unnecessary paging messages as much as possible.

An embodiment of this application is described below in detail with reference to FIG. 2 by using examples. A method illustrated in FIG. 2 is executed by a first device, a first access network device, and a first terminal device.

In some embodiments, the first terminal device may be a terminal device that has or does not have a half-duplex capability. Alternatively, the first terminal device may be a terminal device that supports or does not support a half-duplex mode. Alternatively, the first terminal device may be a terminal device that operates in or not in a half-duplex mode. The half duplex mentioned in embodiments of this application may refer to, for example, half-duplex-frequency division duplex (HD-FDD).

In some embodiments, the first terminal device may be a reduced-capability terminal device (or referred to as a RedCap terminal). The reduced-capability terminal device may be, for example, a reduced-capability terminal device defined in some protocols (such as 3GPP R17).

For example, the first terminal device may be a terminal device applied to an industrial scenario. In a specific example, the first terminal device may be an industrial wireless sensor. Compared to a terminal device in a URLLC scenario, the industrial wireless sensor has a relatively low requirement for delay and reliability. In addition, the industrial wireless sensor typically has lower costs and power consumption than terminal devices in URLLC and eMBB scenarios.

For another example, the first terminal device may be a terminal device applied to a video surveillance scenario (for example, a video surveillance scenario in a smart city or an industrial factory). In a specific example, the first terminal device may be a video surveillance device applied in a smart city. The video surveillance device may collect and process data, so as to more effectively monitor and control urban resources and provide more effective services for urban residents.

For another example, the first terminal device may be a small-sized wearable device. In a specific example, the first terminal device may be a smart watch, smart bracelets, a smart ring, or the like. Alternatively, the wearable device may be an electronic health device, some medical monitoring devices, or the like.

To reduce air interface signalling, rapidly restore wireless connections, and rapidly restore data services, three RRC states are defined for some communications systems (such as an NR system): an RRC idle state (RRC-IDLE), an RRC connected state (RRC_CONNECTED), and an RRC inactive state (RRC_INACTIVE). The first terminal device mentioned in embodiments of this application may be a terminal device in the RRC idle state (RRC-IDLE), may be a terminal device in the RRC connected state (RRC_CONNECTED), or may be a terminal device in the RRC inactive state (RRC_INACTIVE).

For example, the first terminal device may be a terminal device in the RRC idle state. In the RRC idle state, mobility is based on cell reselection by the first terminal device, a paging process is initiated by a CN, and a paging area is configured by the CN. The access network device has no context of the first terminal device, and there is no RRC connection corresponding to the first terminal device.

For another example, the first terminal device may be a terminal device in the RRC connected state. In the RRC connected state, the first terminal device has an RRC connection, and the access network device and the first terminal device have an access stratum (AS) context corresponding to the first terminal device. In addition, in the RRC connected state, the access network device can learn that a location of the first terminal device is of a cell level, mobility of the first terminal device is controlled by the access network device, and unicast data may be transmitted between the first terminal device and the access network device.

For another example, the first terminal device may be a terminal device in the RRC inactive state. In the RRC inactive state, mobility of the first terminal device is based on cell reselection by the terminal device, and there is a connection between the CN and the NR. The AS context of the first terminal device is stored on an access network device. The first terminal device is reachable for an RAN, and a related parameter of the first terminal device may be configured by the RAN. When the first terminal device moves in an RAN notification area (RNA) configured by the RAN, the first terminal device does not need to notify the access network device. When moving out of the RAN notification area, the first terminal device needs to notify the access network device. In the RRC inactive state, a paging process of the first terminal device is triggered by the RAN, and the RAN-based paging area is managed by the RAN. In addition, the access network device can learn that a location of the first terminal device is of an RAN-based paging area level.

In some cases, the first terminal device may be switched from the RRC inactive state (or independently returns to) the RRC idle state. For example, in a case that the first terminal device receives a paging message triggered by the CN, the first terminal device is switched from the RRC inactive state to the RRC idle state. For another example, when the first terminal device initiates an RRC resume request, and a timer T319 is started, in a case that the timer T319 expires, the first terminal device is switched from the RRC inactive state to the RRC idle state. For another example, in a case that integrity protection verification performed by the first terminal device on a message 4 (msg4) fails, the first terminal device is switched from the RRC inactive state to the RRC idle state. For another example, in a process in which the first terminal device performs cell reselection, in a case that the first terminal device selects a cell corresponding to another radio access technology (RAT), the first terminal device is switched from the RRC inactive state to the RRC idle state. For another example, in a case that the first terminal device enters a camp on any cell state, the first terminal device is switched from the RRC inactive state to the RRC idle state.

In some embodiments, the first terminal device may be a terminal device that can access a TN, which is referred to as a TN terminal device. Alternatively, the first terminal device may be a terminal device that can access an NTN, which is referred to as an NTN terminal device. Alternatively, the first terminal device is not only a TN terminal device but also an NTN terminal device.

The first device in FIG. 2 may be a core network (CN) device, such as an AMF. In some other embodiments, the first device may be an access network device, such as an anchor access network device for the first terminal device. The so-called anchor access network device may be an access network device that controls the first terminal device to enter an inactive state. Alternatively, the anchor access network device may be the last access network device that provides a service for the first terminal device when the first terminal device is in the connected state and before the first terminal device enters the inactive state.

The first access network device in FIG. 2 refers to an access network device that can receive a paging message for the first terminal device. In some embodiments, the first access network device may be any one of access network devices within a registration area of the first terminal device. In some embodiments, the first access network device may be any one of access network devices within an RAN notification area of the first terminal device.

Referring to FIG. 2, in step S210, the first access network device receives first information.

In some embodiments, the first information may be sent by the first device mentioned above.

In some embodiments, the first information may be information associated with a paging message received by the first access network device. For example, the first information may be carried in the paging message received by the first access network device. For another example, the first information may not be part of the paging message, but may be information that is transmitted to the first access network device along with the paging message.

The foregoing paging message may be an inter-node paging message. The so-called inter-node paging message may be a paging message between nodes in an access network, for example, a paging message transmitted between access network devices. Alternatively, the inter-node paging message may be a paging message between the access network and the core network, such as a paging message sent by a core network device to an access network device.

In some embodiments, the foregoing paging message (that is, the paging message received by the first access network device) may be a paging message triggered by the CN. The paging message triggered by the CN may be a paging message initiated by the core network device and forwarded by the access network device. The core network device may be, for example, an AMF. Further, in some embodiments, the paging message may be a message sent through an S1 interface. In an example, the paging message may be a paging message in an S1AP message or a user equipment radio paging information (UERadioPagingInformation) message between nodes. In specific implementation, the paging message in the S1AP message or the UERadioPagingInformation message between nodes may be extended, so as to add, to the paging message or the UERadioPagingInformation message between nodes, an information element corresponding to the foregoing first information.

In some embodiments, the foregoing paging message (that is, the paging message received by the first access network device) may be a paging message triggered by the RAN. The paging message triggered by the RAN may be a paging message initiated by an access network device and forwarded by another access network device (for example, the first access network device). The paging message triggered by the RAN may also be referred to as an RAN paging message. The access network device that initiates the paging message may be, for example, the anchor access network device mentioned above. Further, in some embodiments, the paging message may be a message sent through an Xn interface. In an example, the paging message may be a paging message in an XnAP message or a UERadioPagingInformation message between nodes. In specific implementation, the paging message in the XnAP message or the UERadioPagingInformation message between nodes may be extended, so as to add, to the paging message or the UERadioPagingInformation message between nodes, an information element corresponding to the foregoing first information.

In some embodiments, the first information in step S210 may be used to determine whether to transmit (that is, transmit or not transmit) a paging message for the first terminal device.

In some embodiments, the first information may be used to indicate (or determine) a terminal device capability of the first terminal device. Therefore, in some embodiments, the first information may be referred to as capability indication information of the first terminal device.

Indication, by the first information, of a capability of the first terminal device may be implemented in one or more of following manners: the first information indicates that the first terminal device has the terminal device capability, and/or the first information indicates that the first terminal device does not have the terminal device capability.

In an example, the first information may be used to indicate (or determine) one or more of following information: the first terminal device has a half-duplex capability, the first terminal device does not have a half-duplex capability, or the first terminal device has only a half-duplex capability. The so-called “having a half-duplex capability” may be understood as supporting a half-duplex mode (for example, supporting only the half-duplex mode) or operating in the half-duplex mode. In this example, the first information indicates whether the first terminal device has a half-duplex capability. Therefore, the first information may sometimes be referred to as a half-duplex capability indicator.

In another example, the first information may be used to indicate (or determine) one or more of following information: the first terminal device has a capability of accessing the NTN, the first terminal device does not have a capability of accessing the NTN, the first terminal device has only a capability of accessing a non-NTN, the first terminal device is a TN terminal device, or the first terminal device is an NTN terminal device. The so-called “not having a capability of accessing the NTN” may be understood as being unable to access the NTN, or being unable to access an NTN cell. In this example, the first information indicates whether the first terminal device has a capability of accessing the NTN. Therefore, the first information may sometimes be referred to as an NTN capability indicator or a non-NTN capability indicator.

In another example, the first information may be a combination of the foregoing two types of information. For example, the first information may be used to indicate that the first terminal device has or does not have the half-duplex capability, and may be used to indicate that the first terminal device has or does not have the capability of accessing an NTN.

The first information may directly indicate that the first terminal device has or does not have a terminal device capability, or may indirectly indicate that the first terminal device has or does not have a terminal device capability. That the first information indicates that the first terminal device does not have the capability of accessing an NTN is used as an example. The first information may directly indicate whether the first terminal device has the capability of accessing an NTN. Alternatively, the first information may indicate that the first terminal device does not have a capability or some capabilities required for accessing an NTN, thereby indirectly indicating that the first terminal device does not have the capability of accessing an NTN.

In some embodiments, that the first information indicates whether the first terminal device has the capability of accessing an NTN may be replaced with that the first information indicates that the first terminal device has or does not have one or more of following capabilities: a positioning capability; a timing advance (TA) pre-compensation capability; a capability of adjusting a random access procedure based on a round-trip time (RTT) between a terminal device and an access network device; a capability of adjusting a discontinuous reception hybrid automatic repeat request round-trip time timer (DRX HARQ RTT timer) based on an RTT between a terminal device and an access network device; or a capability of supporting a plurality of tracking area codes (TAC).

For example, the first information may indicate that the first terminal device has or does not have the positioning capability. The positioning capability may be, for example, a capability of positioning based on a satellite positioning system. The capability of positioning based on a satellite positioning system may be, for example, a capability of positioning based on a global navigation satellite system (GNSS).

For another example, the first information may indicate that the first terminal device has or does not have the TA pre-compensation capability. The TA pre-compensation capability means that a terminal device may perform TA pre-compensation on a random access request. In other words, the terminal device may send the random access request in advance based on a TA value, so as to adjust a time at which the random access request arrives at the access network device.

For another example, the first information may indicate that the first terminal device has or does not have a capability of adjusting a related process or parameter based on the RTT between the terminal device and the access network device (to access the NTN, it is often necessary to adjust some processes (such as a random access procedure) or parameters based on the RTT). In a specific example, the first information may indicate that the first terminal device has or does not have the capability of adjusting a random access procedure based on the RTT (an RTT from the terminal device to the access network device) (the capability may also be referred to as a random access channel (RACH) adaptation capability). The capability of adjusting a random access procedure may include, for example, a capability of implementing a following function: after sending a preamble, the terminal device may start a random access response (RAR) time window after an interval of the RTT, so as to compensate for a transmission delay of the NTN network. In another specific example, the first information may indicate that the first terminal device has or does not have the capability of adjusting the DRX HARQ RTT timer based on the RTT (an RTT from the terminal device to the access network device). In some embodiments, the DRX HARQ RTT timer may be configured by using RRC signalling. The capability of adjusting the DRX HARQ RTT timer may also be referred to as a DRX HARQ RTT timer extension capability. The capability of adjusting the DRX HARQ RTT timer based on the RTT may include, for example, adding an RTT value to a timing value of the DRX HARQ RTT timer, so as to compensate for the transmission delay of the NTN network.

For another example, the first information may indicate that the first terminal device has or does not have the capability of supporting a plurality of TACs (in the NTN, when the terminal device moves into overlapping areas of a plurality of tracking areas (TA), a plurality of TACs generally need to be simultaneously supported, that is, the TACs respectively corresponding to the plurality of TAs need to be simultaneously supported). The capability of supporting a plurality of TACs may sometimes be referred to as a capability of supporting a soft TAC (soft TAC).

In embodiments of this application, the first information is sent to the first access network device, where the first information may be used to indicate the terminal device capability of the first terminal device. Introduction of the first information helps the access network device determine whether there is a need to send a paging message for the first terminal device, so that a paging resource may be saved, and power consumption for another terminal device to detect a paging message may be reduced.

Referring to FIG. 2, in some embodiments, the method in FIG. 2 may further include step S220, that is, the first access network device determines, based on the first information, whether to transmit (transmit or not transmit) a paging message (or an air interface (Uu) paging message) for the first terminal device. In a case that the first access network device determines to transmit a paging message for the first terminal device, step S230 may continue to be performed, to transmit the paging message for the first terminal device to the first terminal device.

That the first access network device transmits the paging message for the first terminal device may mean that the paging message transmitted by the first access network device includes a paging identity (a paging ID) of the first terminal device. Similarly, that the first access network device does not transmit the paging message for the first terminal device may mean that a paging message transmitted by the first access network device does not include a paging identity (a paging ID) of the first terminal device.

There may be a plurality of implementations for step S220. For example, the first access network device may determine, based on the first information and a device capability supported by the first access network device, whether to transmit a paging message for the first terminal device. The device capability supported by the first access network device corresponds to the terminal device capability. In other words, the device capability supported by the first access network device is a device capability associated with the terminal device capability. For example, the device capability supported by the first access network device and the terminal device capability are of a same type.

In some embodiments, when the terminal device capability indicated by the first information is a first terminal device capability, in a case that the first information indicates that the first terminal device has the first terminal device capability, and the first access network device supports the first terminal device capability, the first access network device transmits a paging message for the first terminal device; and in a case that the first information indicates that the first terminal device has the first terminal device capability, and the first access network device does not support the first terminal device capability, the first access network device does not transmit the paging message for the first terminal device.

For example, in a case that the first information indicates that the first terminal device has the half-duplex capability, and the first access network device supports the half-duplex capability, the first access network device transmits a paging message for the first terminal device.

For another example, in a case that the first information indicates that the first terminal device has the half-duplex capability, and the first access network device does not support the half-duplex capability, the first access network device does not transmit the paging message for the first terminal device.

For example, in a case that the first information indicates that the first terminal device has the capability of accessing an NTN, and the first access network device supports a terminal device that has the capability of accessing an NTN, the first access network device transmits a paging message for the first terminal device.

For another example, in a case that the first information indicates that the first terminal device has the capability of accessing an NTN, and the first access network device does not support a terminal device that has the capability of accessing an NTN, the first access network device does not transmit the paging message for the first terminal device.

In some embodiments, when the terminal device capability indicated by the first information is a second terminal device capability, in a case that the first information indicates that the first terminal device does not have the second terminal device capability, and the first access network device supports the first terminal device capability, the first access network device transmits a paging message for the first terminal device; and in a case that the first information indicates that the first terminal device does not have the second terminal device capability, and the first access network device does not support the first terminal device capability, the first access network device does not transmit the paging message for the first terminal device.

In some embodiments, the foregoing first terminal device capability and the foregoing second terminal device capability are of different types. For example, the first terminal device capability is a capability of accessing a TN, and the second terminal device capability is a capability of accessing an NTN. In other words, in a case that the first information indicates that the first terminal device does not have the capability of accessing an NTN, and the first access network device supports a terminal device that has the capability of accessing a TN, the first access network device transmits a paging message for the first terminal device; and in a case that the first information indicates that the first terminal device does not have the capability of accessing an NTN, and the first access network device does not support a terminal device that has the capability of accessing a TN, the first access network device does not transmit the paging message for the first terminal device.

It should be noted that the first access network device may correspond to one or more cells (that is, one or more cells may be included within a coverage range of the first access network device), and the first access network device may execute a determining logic in step S220 for each cell. For example, step S220 may include: determining, by the first access network device based on the first information and a device capability supported by a first cell (which may be any one of cells corresponding to the first access network device) corresponding to the first access network device, whether to transmit a paging message for the first terminal device within the first cell. It should be understood that, in a case that the first access network device corresponds to a plurality of cells, device capabilities supported by the plurality of cells may be identical or different.

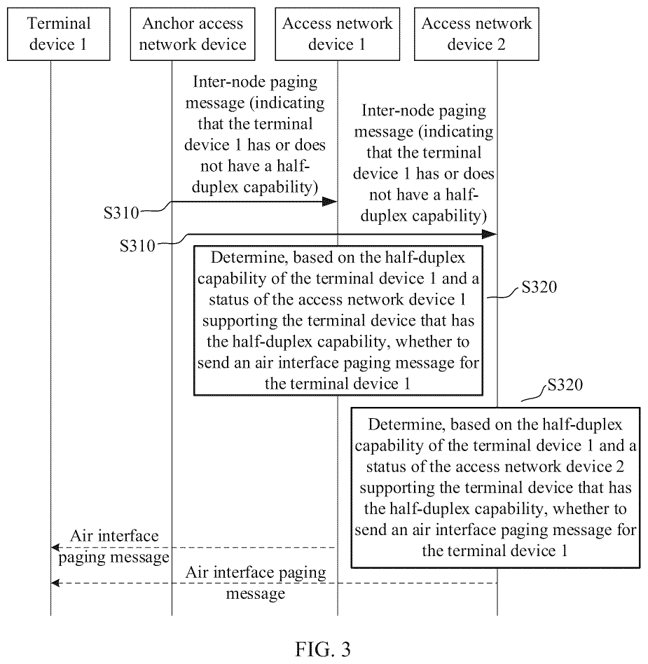

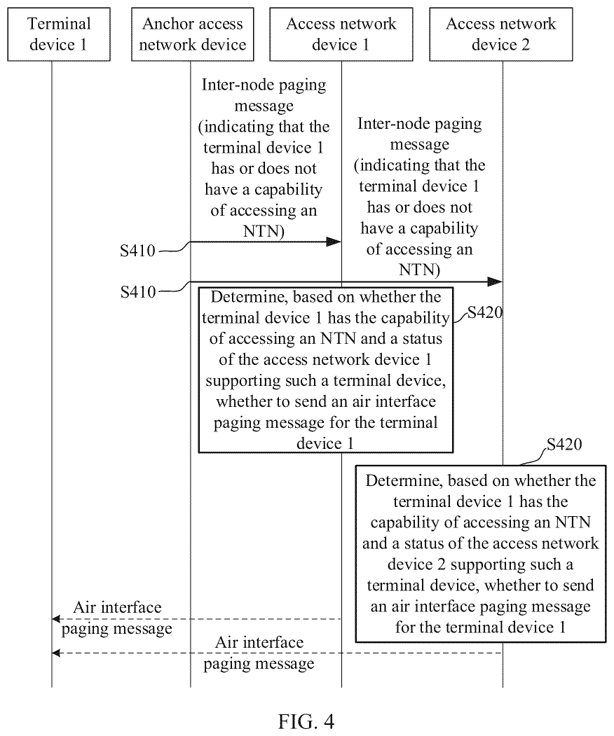

This embodiment of this application is described below in more detail with reference to FIG. 3 and FIG. 4 by using an example in which the first information is carried in an inter-node paging message and the inter-node paging message is triggered by an RAN. It should be noted that the examples in FIG. 3 and FIG. 4 are merely intended to help a person skilled in the art understand embodiments of this application, and are not intended to limit embodiments of this application to a specific value or a specific scenario that is exemplified. Apparently, a person skilled in the art may perform various equivalent modifications or changes based on the examples given in FIG. 3 and FIG. 4, and such modifications or changes also fall within the scope of embodiments of this application.

FIG. 3 shows a terminal device 1, an anchor access network device, an access network device 1, and an access network device 2. The anchor access network device may be an initiator of an inter-node paging message. The first terminal device mentioned above may correspond to the terminal device 1 in FIG. 3. The first access network device mentioned above may correspond to either of the access network device 1 and the access network device 2 in FIG. 3. The first information mentioned above corresponds to information in FIG. 3 that indicates that the terminal device 1 has or does not have the half-duplex capability.

In step S310, the anchor access network device sends an inter-node paging message to the access network device 1 and the access network device 2. The inter-node paging message carries the information (corresponding to the first information mentioned above) indicating that the terminal device 1 has or does not have the half-duplex capability. After receiving the inter-node paging message, the access network device 1 performs step S320, that is, determines, based on the half-duplex capability of the terminal device 1 and a status of the access network device 1 supporting the terminal device that has the half-duplex capability, whether to send an air interface paging message for the terminal device 1. For example, in a case that the terminal device 1 supports only the half-duplex capability, and a current cell supports access of a terminal device having the half-duplex capability, the access network device 1 transmits, in the current cell, an air interface paging message for the terminal device 1. For another example, in a case that the terminal device 1 supports only the half-duplex capability, and a current cell does not support access of a terminal device having the half-duplex capability, the access network device 1 transmits, in the current cell, no air interface paging message for the terminal device 1. The access network device 2 may determine, by using a same or similar determining logic as the access network device 1, whether to send an air interface paging message for the terminal device 1. Details are not described herein again.

FIG. 4 shows a terminal device 1, an anchor access network device, an access network device 1, and an access network device 2. The anchor access network device may be an initiator of an inter-node paging message. The first terminal device mentioned above may correspond to the terminal device 1 in FIG. 4. The first access network device mentioned above may correspond to either of the access network device 1 and the access network device 2 in FIG. 4. The first information mentioned above corresponds to information in FIG. 4 that indicates that the terminal device 1 has or does not have the capability of accessing an NTN.

In step S410, the anchor access network device sends an inter-node paging message to the access network device 1 and the access network device 2. The inter-node paging message carries the information (corresponding to the first information mentioned above) indicating that the terminal device 1 has or does not have the capability of accessing an NTN. After receiving the inter-node paging message, the access network device 1 performs step S420, that is, determines, based on whether the terminal device 1 has the capability of accessing an NTN and a status of the access network device 1 supporting such a terminal device, whether to send an air interface paging message for the terminal device 1 to the terminal device 1. For example, in a case that the terminal device 1 can access only a non-NTN, and the current cell can support access of such a terminal device, the access network device 1 transmits, in the current cell, an air interface paging message for the terminal device 1. For another example, in a case that the terminal device 1 can access only a non-NTN, and the current cell does not support access of such a terminal device, the access network device 1 transmits, in the current cell, no air interface paging message for the terminal device 1. The access network device 2 may determine, by using a same or similar determining logic as the access network device 1, whether to send an air interface paging message for the terminal device 1. Details are not described herein again.

The method embodiments of this application are described in detail above with reference to FIG. 1 to FIG. 4. Apparatus embodiments of this application are described below in detail with reference to FIG. 5 to FIG. 7. It should be understood that the description of the method embodiments corresponds to the description of the apparatus embodiments, and therefore, for parts that are not described in detail, reference may be made to the foregoing method embodiments.

FIG. 5 is a schematic structural diagram of a communications apparatus according to an embodiment of this application. The communications apparatus 500 shown in FIG. 5 may be located in a first access network device. The communications apparatus 500 may include a communications module 510. The communications module 510 may be configured to receive first information, where the first information is used to indicate a terminal device capability of a first terminal device.

Optionally, in some embodiments, the communications apparatus 500 may further include a determining module 520, configured to determine, based on the first information, whether to transmit a paging message for the first terminal device.

Optionally, in some embodiments, the determining module 520 is configured to determine, based on the first information and a device capability supported by the first access network device, whether to transmit a paging message for the first terminal device, where the device capability supported by the first access network device corresponds to the terminal device capability.

Optionally, in some embodiments, when the terminal device capability indicated by the first information is a first terminal device capability, the determining module 520 is configured to: in a case that the first information indicates that the first terminal device has the first terminal device capability, and the first access network device supports the first terminal device capability, transmit a paging message for the first terminal device; and in a case that the first information indicates that the first terminal device has the first terminal device capability, and the first access network device does not support the first terminal device capability, transmit no paging message for the first terminal device.

Optionally, in some embodiments, the first terminal device capability is a half-duplex capability or a capability of accessing a non-terrestrial network.

Optionally, in some embodiments, when the terminal device capability indicated by the first information is a second terminal device capability, the determining module 520 is configured to: in a case that the first information indicates that the first terminal device does not have the second terminal device capability, and the first access network device supports the first terminal device capability, transmit a paging message for the first terminal device; and in a case that the first information indicates that the first terminal device does not have the second terminal device capability, and the first access network device does not support the first terminal device capability, transmit no paging message for the first terminal device.

Optionally, in some embodiments, the foregoing first terminal device capability and the foregoing second terminal device capability are of different types.

Optionally, in some embodiments, the first terminal device capability is a capability of accessing a terrestrial network, and the second terminal device capability is a capability of accessing a non-terrestrial network.

Optionally, in some embodiments, the first information indicates that the first terminal device has or does not have the half-duplex capability; and/or the first information indicates that the first terminal device has or does not have the capability of accessing a non-terrestrial network.

Optionally, in some embodiments, the capability of accessing a non-terrestrial network includes one or more of following capabilities: a positioning capability; a timing advance pre-compensation capability; a capability of adjusting a random access procedure based on a round-trip time between a terminal device and an access network device; a capability of adjusting a discontinuous reception hybrid automatic repeat request round-trip time timer based on a round-trip time between a terminal device and an access network device; or a capability of supporting a plurality of tracking area codes.

Optionally, in some embodiments, the first information is carried in a paging message received by the first access network device.

Optionally, in some embodiments, the first information is carried in a paging message triggered by a radio access network or a paging message triggered by a core network.

Optionally, in some embodiments, the first information is carried in one of following messages: a paging message in an S1 application protocol message; a user equipment radio paging information message in an S1 application protocol message; a paging message in an Xn application protocol message; or a user equipment radio paging information message in an Xn application protocol message.

Optionally, in some embodiments, the first terminal device is a reduced-capability terminal device.

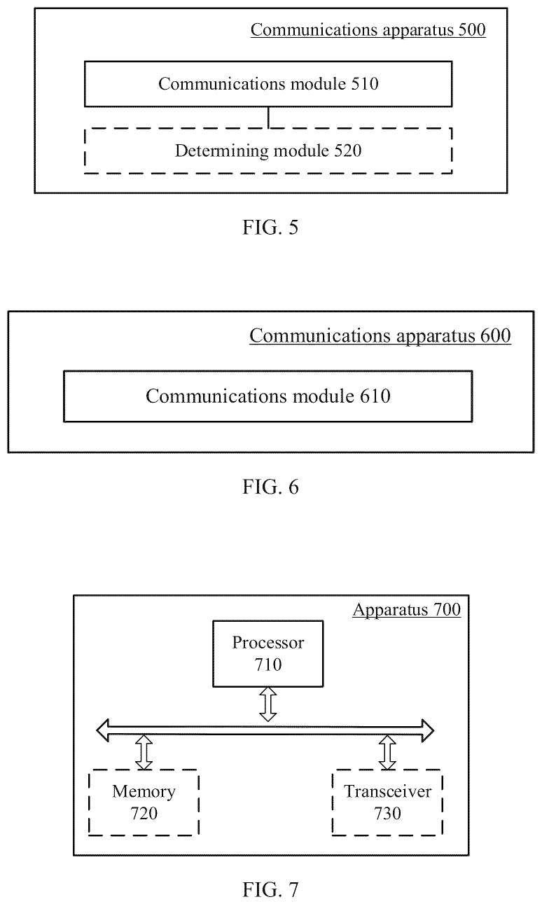

FIG. 6 is a schematic structural diagram of a communications apparatus according to another embodiment of this application. The communications apparatus 600 in FIG. 6 may be located in an access network device (for example, located in an anchor access network device for a first terminal device described below), or may be located in a core network device. The communications apparatus 600 may include a communications module 610. The communications module 610 may be configured to send first information to a first access network device, where the first information is used to indicate a terminal device capability of a first terminal device.

Optionally, in some embodiments, the first information is used to determine whether to transmit a paging message for the first terminal device.

Optionally, in some embodiments, the first information is used by the first access network device, based on the first information and a device capability supported by the first access network device, whether to transmit a paging message for the first terminal device, where the device capability supported by the first access network device corresponds to the terminal device capability.

Optionally, in some embodiments, when the terminal device capability indicated by the first information is a first terminal device capability, the determining, based on the first information and a device capability supported by the first access network device, whether to transmit a paging message for the first terminal device includes: in a case that the first information indicates that the first terminal device has the first terminal device capability, and the first access network device supports the first terminal device capability, transmitting a paging message for the first terminal device; and in a case that the first information indicates that the first terminal device has the first terminal device capability, and the first access network device does not support the first terminal device capability, transmitting no paging message for the first terminal device.

Optionally, in some embodiments, the first terminal device capability is a half-duplex capability or a capability of accessing a non-terrestrial network.

Optionally, in some embodiments, when the terminal device capability indicated by the first information is a second terminal device capability, the determining, based on the first information and a device capability supported by the first access network device, whether to transmit a paging message for the first terminal device includes: in a case that the first information indicates that the first terminal device does not have the second terminal device capability, and the first access network device supports the first terminal device capability, transmitting a paging message for the first terminal device; and in a case that the first information indicates that the first terminal device does not have the second terminal device capability, and the first access network device does not support the first terminal device capability, transmitting no paging message for the first terminal device.

Optionally, in some embodiments, the foregoing first terminal device capability and the foregoing second terminal device capability are of different types.

Optionally, in some embodiments, the first terminal device capability is a capability of accessing a terrestrial network, and the second terminal device capability is a capability of accessing a non-terrestrial network.

Optionally, in some embodiments, the first information indicates that the first terminal device has or does not have the half-duplex capability; and/or the first information indicates that the first terminal device has or does not have the capability of accessing a non-terrestrial network.

Optionally, in some embodiments, the capability of accessing a non-terrestrial network includes one or more of following capabilities: a positioning capability; a timing advance pre-compensation capability; a capability of adjusting a random access procedure based on a round-trip time between a terminal device and an access network device; a capability of adjusting a discontinuous reception hybrid automatic repeat request round-trip time timer based on a round-trip time between a terminal device and an access network device; or a capability of supporting a plurality of tracking area codes.

Optionally, in some embodiments, the first information is carried in a paging message received by the first access network device.

Optionally, in some embodiments, the first information is carried in a paging message triggered by a radio access network or a paging message triggered by a core network.

Optionally, in some embodiments, the first information is carried in one of following messages: a paging message in an S1 application protocol message; a user equipment radio paging information message in an S1 application protocol message; a paging message in an Xn application protocol message; or a user equipment radio paging information message in an Xn application protocol message.

Optionally, in some embodiments, the first terminal device is a reduced-capability terminal device.

FIG. 7 is a schematic structural diagram of an apparatus according to an embodiment of this application. Dashed lines in FIG. 7 indicate that units or modules are optional. The apparatus 700 may be configured to implement the methods described in the foregoing method embodiments. The apparatus 700 may be a chip, a terminal device, or an access network device.

The apparatus 700 may include one or more processors 710. The processor 710 may allow the apparatus 700 to implement the methods described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 700 may further include one or more memories 720. The memory 720 stores a program, where the program may be executed by the processor 710, to cause the processor 710 to perform the methods described in the foregoing method embodiments. The memory 720 may be separately from the processor 710 or may be integrated into the processor 710.

The apparatus 700 may further include a transceiver 730. The processor 710 may communicate with another device or chip by using the transceiver 730. For example, the processor 710 may send data to and receive data from another device or chip by using the transceiver 730.

An embodiment of this application further provides a computer-readable storage medium for storing a program. The computer-readable storage medium may be applied to a communications apparatus provided in embodiments of this application, and the program causes a computer to execute the methods in various embodiments of this application.

An embodiment of this application further provides a computer program product. The computer program product includes a program. The computer program product may be applied to a communications apparatus provided in embodiments of this application, and the program causes a computer to execute the methods in various embodiments of this application.

An embodiment of this application further provides a computer program. The computer program may be applied to a communications apparatus provided in embodiments of this application, and the computer program causes a computer to execute the methods in various embodiments of this application.

It should be understood that, in embodiments of this application, “B that is corresponding to A” means that B is associated with A, and B may be determined based on A. However, it should also be understood that, determining B based on A does not mean determining B based only on A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of embodiments of this application.

In the several embodiments provided in this application, it should be understood that the disclosed system, apparatus, and method may be implemented in another manner. For example, the apparatus embodiments described above are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
sending first information to a first access network device, wherein
the first information is used to indicate a terminal device capability of a first terminal device.

2. The method according to claim 1, wherein
the first information is used to determine whether to transmit a paging message for the first terminal device.

3. The method according to claim 2, wherein
the first terminal device capability is a half-duplex capability or a capability of accessing a non-terrestrial network.

4. The method according to claim 1, wherein
the first information indicates that the first terminal device has or does not have a half-duplex capability; and/or
the first information indicates that the first terminal device has or does not have a capability of accessing a non-terrestrial network.

5. The method according to claim 1, wherein
the first information is carried in a paging message received by the first access network device.

6. The method according to claim 5, wherein
the first information is carried in a paging message triggered by a radio access network or a paging message triggered by a core network.

7. The method according to claim 1, wherein
the first terminal device is a reduced-capability terminal device.

8. An apparatus, comprising a processor configured to invoke a program from a memory to perform:
sending first information to a first access network device, wherein the first information is used to indicate a terminal device capability of a first terminal device.

9. The apparatus according to claim 8, wherein
the first information is used to determine whether to transmit a paging message for the first terminal device.

10. The apparatus according to claim 9, wherein
the first terminal device capability is a half-duplex capability or a capability of accessing a non-terrestrial network.

11. The apparatus according to claim 8, wherein
the first information indicates that the first terminal device has or does not have a half-duplex capability; and/or
the first information indicates that the first terminal device has or does not have a capability of accessing a non-terrestrial network.

12. The apparatus according to claim 8, wherein the first information is carried in a paging message received by the first access network device.

13. The apparatus according to claim 12, wherein
the first information is carried in a paging message triggered by a radio access network or a paging message triggered by a core network.

14. The apparatus according to claim 8, wherein
the first terminal device is a reduced-capability terminal device.

15. An apparatus, comprising a processor configured to invoke a program from a memory to perform:
receiving first information, wherein the first information is used to indicate a terminal device capability of a first terminal device.

16. The apparatus according to claim 15, wherein
the first terminal device capability is a half-duplex capability or a capability of accessing a non-terrestrial network.

17. The apparatus according to claim 15, wherein
the first information indicates that the first terminal device has or does not have a half-duplex capability; and/or
the first information indicates that the first terminal device has or does not have a capability of accessing a non-terrestrial network.

18. The apparatus according to claim 15, wherein
the first information is carried in a paging message received by the first access network device.

19. The apparatus according to claim 18, wherein
the first information is carried in a paging message triggered by a radio access network or a paging message triggered by a core network.

20. The apparatus according to claim 15, wherein
the first terminal device is a reduced-capability terminal device.
